(19) United States
(12) Patent Application Publication
(10) Pub. No.: US 2023/0411742 A1
(43) Pub. Date: Dec. 21, 2023

(54) LAMINATES FOR LITHIUM-ION BATTERIES AND METHOD FOR PREPARING SAME

(71) Applicant: BLUE SOLUTIONS CANADA INC., Boucherville (CA)

(72) Inventors: Philippe PERRET, La Prairie (CA); Michel PARENT, Boucherville (CA); Dave LESSARD, Boucherville (CA); Francois LAPIERRE, Boucherville (CA); Frederic COTTON, Montreal (CA); Patrick LEBLANC, Boucherville (CA)

(21) Appl. No.: 18/207,255

(22) Filed: Jun. 8, 2023

Related U.S. Application Data
(60) Provisional application No. 63/350,262, filed on Jun. 8, 2022.

(51) Int. Cl. H01M 50/129; H01M 10/0525

(52) U.S. Cl. CPC H01M 50/129; H01M 10/0525

(57) ABSTRACT

The present technology relates to laminates for lithium-ion batteries comprising at least one cathode layer; at least one anode layer; at least one electrolyte layer disposed between the at least one cathode layer and the at least one anode layer; and a viscosity modifier present on at least a portion of the laminate which limits the penetration of reactive fluids into the laminate and thereby controls the extent of oxidization of the anode, and prevents the formation of dendrites in said laminate. The present technology further relates to methods for preparing such laminates, and lithium-ion batteries comprising same.

### CROSS-REFERENCE TO RELATED APPLICATION

This application claims the benefit of and priority to U.S. provisional patent application No. 63/350,262, filed on Jun. 8, 2022; the content of which is herein incorporated in entirety by reference.

### TECHNICAL FIELD

The present technology relates to laminates for lithium-ion batteries, and in particular to laminates which are electrically insulated, and methods for preparing same.

### BACKGROUND

Lithium-ion batteries are presently vastly used in consumer electronics and electric vehicles. These rechargeable batteries display many advantages over conventional liquid electrolyte batteries, including low battery weight, and high power density, specific energy and capacity retention, which make them particularly suitable for such uses.

Lithium-ion batteries are manufactured from laminates made of solid polymer electrolytes and sheet-like electrodes. Such laminates typically include thin films of an alkali metal anode (or negative electrode); a cathode (or positive electrode); a separator capable of permitting ionic conductivity sandwiched therebetween; and a current collector which can be associated with the cathode, which together form an individual electrochemical cell (EC). A plurality of ECs are then stacked together to form a battery.

Laminates are generally manufactured through a continuous process wherein thin films of anode, electrolyte separator, cathode and current collector are layered one on top another, and then cut to size perpendicular to their longitudinal axis. The cutting operation, however, exposes the edges of each layer of the laminate and may cause burring of the anode with the cathode and/or the current collector layers. The burred metal edges may then extend over the electrolyte separator and contact the opposite anode or cathode thereby causing a short circuit, which renders the laminate unusable. Having exposed edges of the anodes and cathode and/or current collector layers in such close proximity in the laminate, and to other laminates during the stacking process, also increases the chances of having short circuits, even in the absence of burring.

For these reasons, the cut edges of the laminates are typically electrically insulated by applying a reactive fluid onto at least one side of the laminate or bundle such as to oxidize an exposed edge of the alkali metal anodes and to thereby damage a portion of the exposed edge, as previously disclosed in WO 2004/079836 (incorporated herein by reference). The reactive fluid is typically water, exposure to which causes the exposed edge of the alkali metal anode to recede away from the exposed side of the bundle which prevents electrical contact between the anodes and adjacent cathodes/current collectors. The laminates obtained by this process are thus said to be cauterized.

Cauterization with reactive fluids, however, suffers from other disadvantages. In practice the cut made in the laminate results in small separations between the cathode and the adjacent layers of the laminate at the cut edge, such that the cathode does not interface completely with the adjacent layers. This allows for the reactive fluid, upon application, to enter between the layers of the laminate via capillary action and to attack the alkali metal anode over large surface areas including both at the cut and longitudinal edges of the laminate. This in turn increases the formation of dendrites on the anode and further causes short circuits.

Therefore, there is a need for alternative or improved laminates and methods for preparing same which overcome or reduce at least some of the above-described problems.

### SUMMARY

From one aspect, the present technology relates to a laminate for a lithium-ion battery comprising at least one cathode layer, at least one anode layer, at least one electrolyte layer disposed between the at least one cathode layer and the at least one anode layer, and a viscosity modifier present on at least a portion of the laminate; wherein the viscosity modifier limits penetration of a reactive fluid into the laminate.

From another aspect, the present technology relates to batteries comprising said laminates.

From another aspect, the laminates of the present technology have reduced dendrite formation.

From another aspect, the laminates of the present technology comprise a plug comprising a viscosity modifier on at least one edge of the laminate. In some embodiments, the at least one edge is the cut edge of the laminate.

From another aspect, the methods of the present technology allow for controlled oxidization of the metal anode by the reactive fluid comprising the viscosity modifier.

From another aspect, the methods of the present technology utilize an optimized volume of reactive fluid for the oxidization of the anode compared to methods known in the art.

From another aspect, the methods of the present technology do not include an aspiration step for removing the excess reactive fluid following the application of the viscous composition to the edge of the laminate.

### BRIEF DESCRIPTION OF THE DRAWINGS

Reference will now be made to the accompanying drawings.

FIG. 1 illustrates a schematic representation of a cross-sectional view of a battery comprising laminates according to the certain embodiments of the present technology.

FIG. 2A illustrates a schematic representation of a bi-face electrochemical cell bundle or battery as known in the art.

FIG. 2B illustrates a schematic representation of a mono-face electrochemical cell bundle or battery as known in the art.

FIG. 3A illustrates a schematic representation of a side elevation view of the battery of FIG. 1. FIG. 3B illustrates a schematic representation of a top view of the battery of FIG. 1.

FIG. 4 illustrates a comparison of the shear thinning of viscous compositions according to certain embodiments of the present technology comprising carboxymethyl cellulose (CMC), carbomer, Xanthan gum and Laponite.

FIGS. 5A-5F illustrate optical microscope images taken through the thickness of a battery according to certain embodiments of the present technology. FIGS. 5A, 5B and 5C illustrate images taken respectively from the top, middle and bottom of a first zone near the cut edge of the battery. FIGS. 5D, 5E, 5F are representative images taken respectively from the top, middle and bottom of a second zone near the cut edge of the battery.

FIG. 6 is a photograph of a side elevation view of a battery according to another embodiment.

FIG. 7 illustrates a schematic representation of a perspective view of an apparatus used for applying a viscous composition according to certain embodiments of the present technology to a laminate.

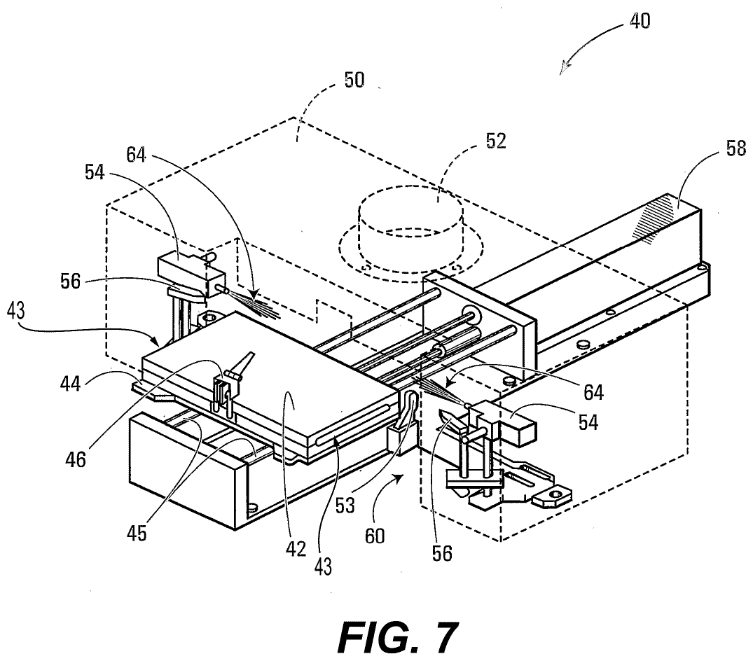

### DETAILED DESCRIPTION

### Definition

The use of “including”, “comprising”, or “having”, “containing”, “involving” and variations thereof herein, is meant to encompass the items listed thereafter as well as, optionally, additional items. In the following description, the same numerical references refer to similar elements.

It must be noted that, as used in this specification and the appended claims, the singular form “a”, “an” and “the” include plural referents unless the context clearly dictates otherwise.

As used herein, the term “about” in the context of a given value or range refers to a value or range that is within 20%, preferably within 10%, and more preferably within 5% of the given value or range.

As used herein, the term “and/or” is to be taken as specific disclosure of each of the two specified features or components with or without the other. For example, “A and/or B” is to be taken as specific disclosure of each of (i) A, (ii) B and (iii) A and B, just as if each is set out individually herein.

The recitation herein of numerical ranges by endpoints is intended to include all numbers subsumed within that range (e.g., a recitation of 1 to 5 includes 1, 1.25, 1.33, 1.5, 2, 2.75, 3, 3.80, 4, 4.32, and 5).

In the context of the present specification, unless expressly provided otherwise, the words “first”, “second”, “third”, etc. . . . have been used as adjectives only for the purpose of allowing for distinction between the nouns that they modify from one another, and not for the purpose of describing any particular relationship between those nouns. Thus, for example, it should be understood that, the use of the terms “first cut edge” and “second cut edge” are not intended to imply any particular order, type, chronology, hierarchy or ranking (for example) of/between the cut edges, nor are their use (by itself) intended to imply that any “second cut edge” must necessarily exist in any given situation.

As used herein, the expression “viscosity modifier” refers to any compound which increases the viscosity of a given fluid or decreases its flow properties.

As used herein, the expression “non-Newtonian shear thinning agent” refers to any compound which gives a given fluid shear thinning properties. As used herein “Shear thinning” refers to the non-Newtonian behavior of fluids whose viscosity decreases under shear stress.

As used herein, the expression “thixotropic agent” refers to any compound which gives a given fluid a time-dependent shear thinning property.

As used herein, the term “edge of the laminate” refers to a cut edge of the laminate and/or a longitudinal edge of the laminate.

As used herein, the term “Laponite” refers to a synthetic layered silicate which is insoluble in water and other solvents but hydrates and swells in such solvents to give a clear colloidal dispersion.

As used herein, the expression “viscous composition” refers to a composition comprising a viscosity modifier and a reactive fluid.

As used herein, the expression “reactive fluid” refers to a fluid which is able to oxidize an alkali metal.

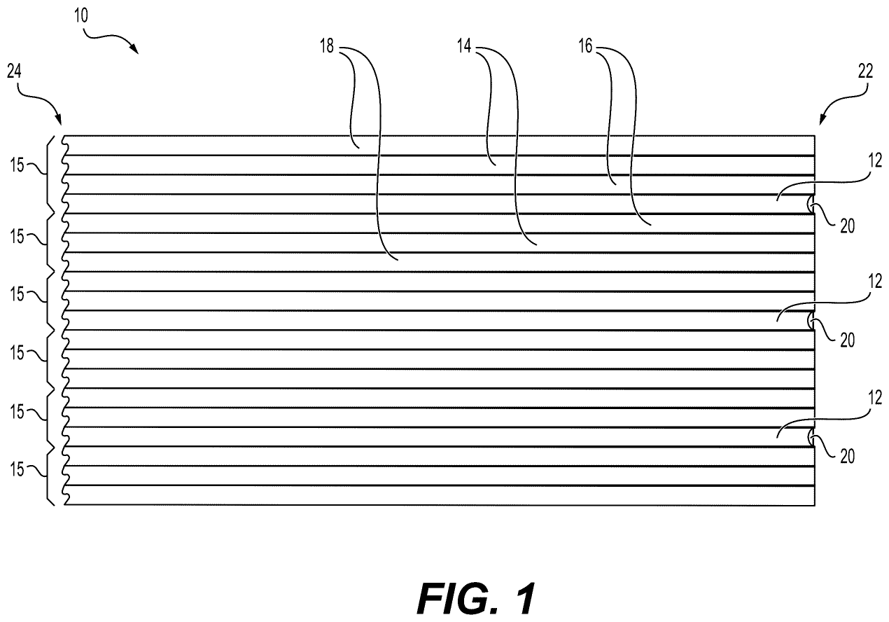

FIG. 1 illustrates a lithium-ion battery 10 according to certain embodiments of the present technology. The battery 10 comprises a plurality of individual laminates 15 stacked one on top of another. Each laminate 15 comprises a thin-filmed alkali metal anode layer 12 made of alkali metals or alloys thereof, such as lithium metal, lithium-aluminum alloys, or lithium-based compounds; a cathode layer 14, made of a composite material; an electrolyte layer 16 disposed between the cathode layer and the anode layer, generally made of a solid polymer electrolyte, and a plug 20 covering the edge of the alkali metal anode layer 12 formed by the presence of a viscosity modifier on a first cut edge 22 of the laminate 15. The laminate also comprises a second cut edge 24 which will be discussed further below.

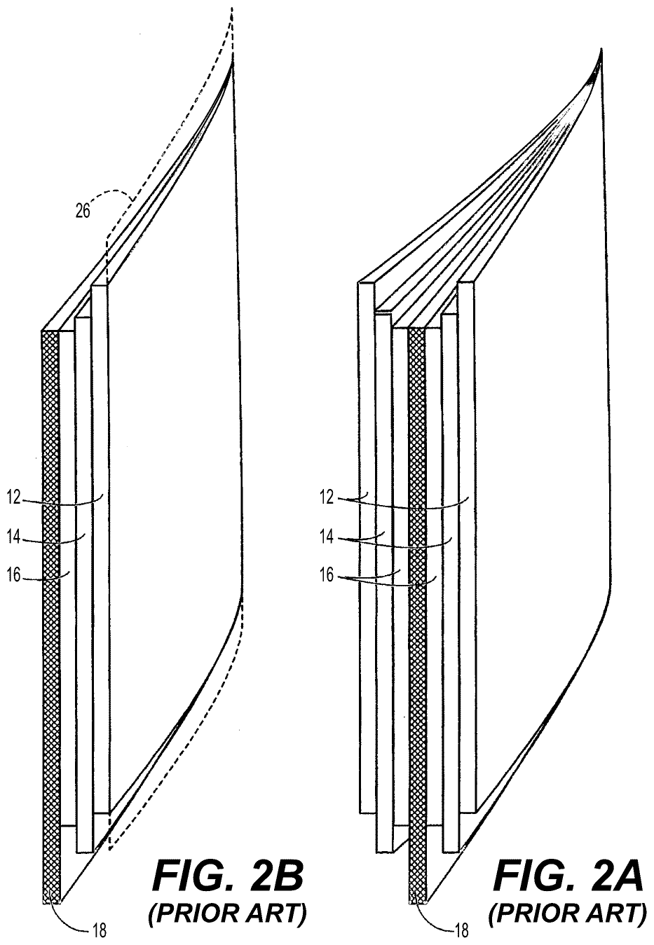

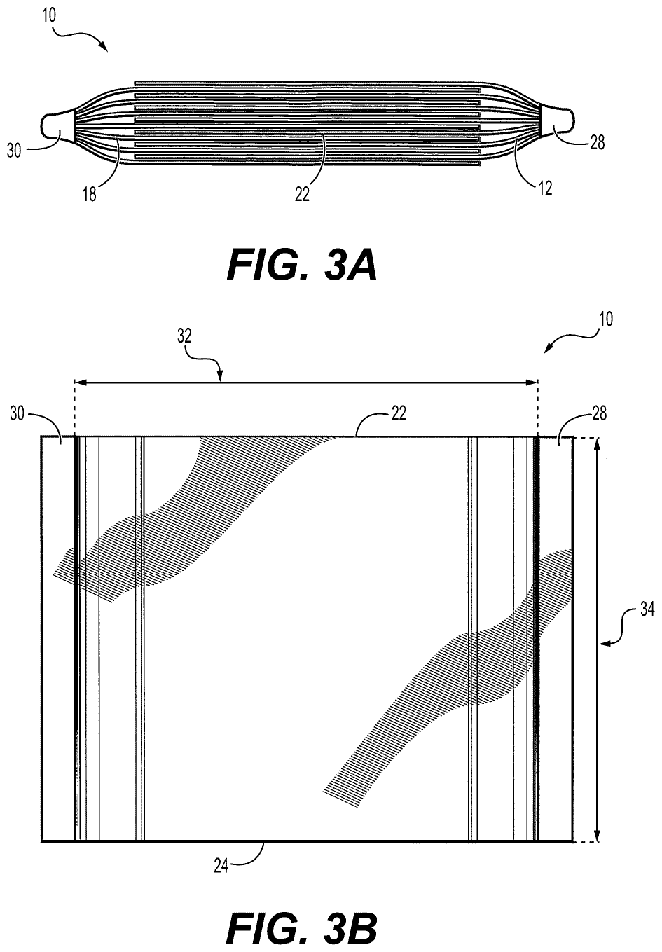

The laminate 15, in these embodiments, further comprises current collector layer 18 made of thin-film sheets of aluminum associated with cathode layer 14. Individual laminates 15 are stacked together in a bi-face configuration, meaning that the adjacent laminates 15 have a common or central current collector 18 having a cathode layer 14 on both its sides, electrolyte layer 16 adjacent each cathode layer 14, and alkali metal anode layers 12 adjacent each electrolyte layer 16 (FIG. 2A). In other embodiments, individual laminates 15 may be stacked in mono-face configuration having individual laminates 15 separated by an insulating film 26, such as a polypropylene film, to insulate adjacent laminates from one another and prevent short circuits (FIG. 2B).

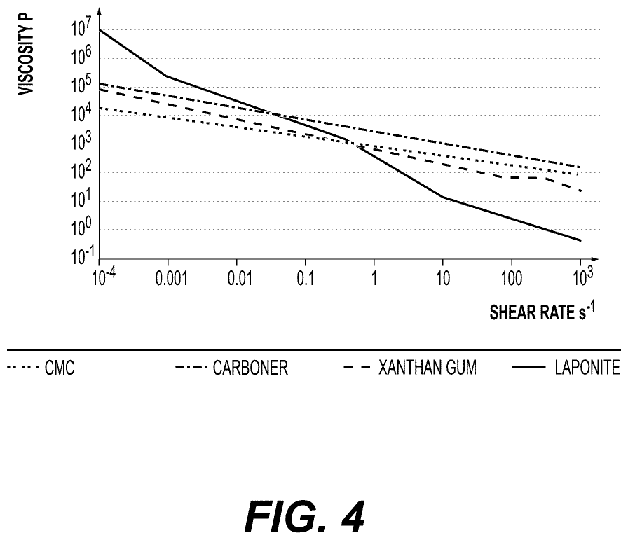

As best seen in FIG. 3A, layers of the laminate 15 are stacked together such that alkali metal anode layers 12 and cathode current collector 18 protrude at opposite ends (i.e., longitudinal edges) of the battery 10. The protruding ends of the alkali metal anode layers 12 of the laminates are electrically connected together by any suitable means to form a negative pole 28. At the opposite end, protruding ends of the cathode current collector 18 are also electrically connected together by any suitable means to form the positive pole 30 of the battery 10.

The first and second cut edges 22 and 24 consist of cut ends of the laminate (FIG. 3B). As schematically illustrated at the second cut edge 24 in FIG. 1, the cut leaves the layers of the laminate exposed. In addition, the cutting action burs the sides of the alkali metal anode layers 12, electrolyte layer 16, cathode layer 14, and current collector layers 18 in such a way that electrical contacts between these layers may occur, which can cause localized short circuits, and significantly reduce the performance of the laminate.

As described above, one approach to prevent or reduce the formation of short circuits, and to electrically insulate the cut edges has been to cauterize edges 22 and/or 24 with a reactive fluid, to oxidize the alkali metal anodes. This causes the edges of the alkali metal anode layers 12 to recede and to thereby electrically insulate the anode layers 12 from adjacent cathodes layers 14 and/or current collector layers 18. The oxidization of the anode, as disclosed in WO 2004/079836 (incorporate herein by reference), is generally performed by the application of a reactive fluid, and more specifically spraying of water, directly to the cut edges.

In the present technology, however, cauterization is performed by the application of a composition comprising a viscosity modifier and a reactive fluid, also referred to as a viscous composition. Addition of the viscosity modifier to the reactive fluid causes the reactive fluid to become viscous. In some instances, the viscous composition may be fluid under shear stress or force, such as that induced during spraying, and may set into a viscous gel or form a solid plug 20 which coats the laminate 15 under static conditions at room temperature, and prevents movement of the reactive fluid into the laminate. The viscous composition therefore allows both the edges of the alkali metal anode layers 12 to partly dissolve and recede away from the cut edge due to the presence of the reactive fluid, thereby leaving a void in its stead, and to form the plug 20 in said void due to the presence of the viscosity modifier. This, in turn, prevents the formation of dendrites and the short circuits seen when a reactive fluid is used alone (i.e., without a viscosity modifier). Furthermore, the formation of the plug 20 controls the extent of oxidization of the metal anode by the reactive fluid, and prevents the anode from recessing extensively from the cut edge 22.

In certain embodiments, the reactive fluid in which the viscosity modifier is suspended in is water, a low mass alcohol, or a combination thereof In some embodiments, the low mass alcohol is methanol, ethanol, 1-propanol, 2-propanol, or combinations thereof. In other embodiments, the water is distilled water, deionized water, or distilled and deionized water. In yet other embodiments, the water is deionized water. In some embodiments, use of deionized water as the reactive fluid in viscous compositions comprising Laponite may be advantageous, as calcium and magnesium ions present in hard water (such as in water containing CaCO₃ and/or MgCO₃) may reduce the rate of hydration, especially in gel forming grades of Laponite, and cause a reduction in efficiency of viscosity build. In further embodiments, the water is distilled water. Advantageously, all reactive fluids presented above are able to react with the alkali metal anode in a short amount of time which renders them particularly suitable for the laminates and methods of the present technology.

In other embodiments, the viscous composition may further comprise a catalyst to assist the viscosity modifier in augmenting the viscosity of the reactive fluid or to accelerate gelling. In some embodiments, the catalyst is NaCl, LiOH, or a combination thereof.

In further embodiments, the viscous composition may also comprise a colorant to detect application of the viscous composition onto the cut edge of the laminate. Suitable colorants for the viscous compositions of the present technology include, but are not limited to, fluorescent tracers. In certain embodiments, the fluorescent tracer is Tinopal. In other embodiments, the viscous composition comprises the colorant, the fluorescent tracer or Tinopal at a concentration ranging from about 0.1 g/L to about 2.0 g/L, from about 0.25 g/L to about 1.5 g/L, or from about 0.5 g/L to about 1.0 g/L.

In certain embodiments, the viscosity modifier is a non-Newtonian shear thinning agent, a viscous polymer, or a combination thereof In some embodiments, the non-Newtonian shear thinning agent is a thixotropic agent. In other embodiments, the thixotropic agent is a synthetic argyle, a natural argyle, or a combination thereof. In further embodiments, the synthetic argyle is Laponite. In yet further embodiments, the natural argyle is a smectite clay. In other embodiments, the smectite clay is Montmorillonite, Bentonite, or a combination thereof. In yet other embodiments, the viscous polymer is a polyvinyl alcohol, a crosslinked polyacrylic acid polymer, a vegetable polymer, or combinations thereof In further embodiments, the vegetable polymer is Xanthan, Agar, carboxymethyl cellulose, or combinations thereof. In yet further embodiments, the viscosity modifier is Laponite. In other embodiments, the viscosity modifier is Laponite and the reactive fluid is distilled and/or deionized water.

In certain embodiments, the reactive fluid comprises the viscosity modifier in an amount ranging from about 1% w/w to about 5% w/w of the total mass of the reactive fluid. In other embodiments, the reactive fluid comprises the viscosity modifier in an amount ranging from about 1% w/w to about 2% w/w, from about 1% w/w to about 3% w/w, from about 1% w/w to about 4% w/w, from about 2% w/w to about 5% w/w, from about 2% w/w to about 3% w/w, from about 2% w/w to about 4% w/w, from about 3% w/w to about 5% w/w, from about 3% w/w to about 4% w/w, or from about 4% w/w to about 5% w/w of the total mass of the reactive fluid. In further embodiments, the reactive fluid comprises the viscosity modifier in an amount ranging from about 2.0% w/w to about 3.5% w/w of the total mass of the reactive fluid. In one particular embodiment, the reactive fluid comprises the viscosity modifier in an amount of about 2.3% w/w of the total mass of the reactive fluid.

In other embodiments, the viscous composition of the present technology has a jelly-like consistency under static conditions, at room temperature, and has a dynamic viscosity of between about 1×10⁸ Poise (P) and about 1×10⁶ P. In further embodiments, the viscous composition of the present technology has a dynamic viscosity of about 1×10⁷ Poise (P) under static conditions at room temperature. In other embodiments the viscous composition of the present technology is liquid under shear stress at room temperature and has a dynamic viscosity of between about 1 cP and about 100 cP. In further embodiments, the viscous composition of the present technology has a dynamic viscosity of about 30 cP under shear stress at room temperature. Dynamic viscosity is a measure of the shear stress per unit area required before a sample begins to deform. The Dynamic viscosity of the viscous compositions of the present technology may be measured by a rotational viscometer. Rotational viscometers work by measuring the torque required to rotate an object in the test fluid. The torque maintaining the set speed is directly proportional to the viscosity; therefore, the apparatus is capable of outputting viscosity, shear stress and shear rate values.

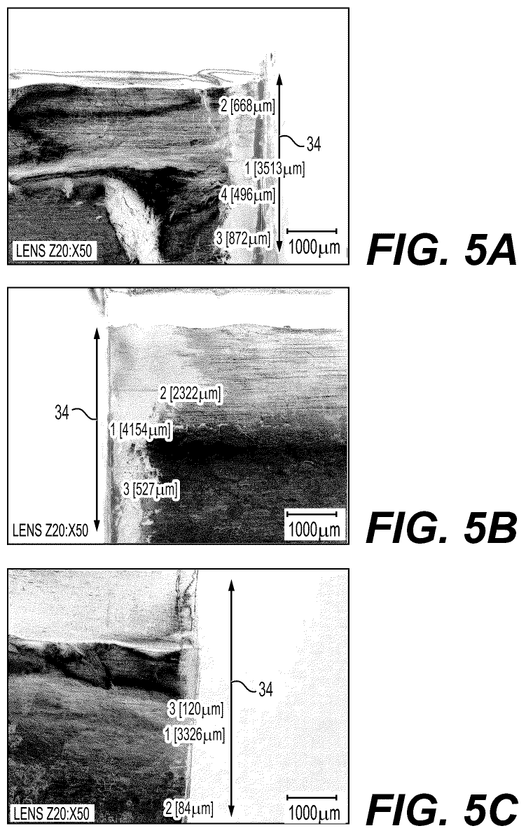

As illustrated in FIG. 4, in some embodiments, the viscous composition of the present technology starts to deform under shear rates of at least about 0.0001 s⁻¹. In other embodiments, the viscous composition of the present technology deforms under shear rates of between about 0.0001 s⁻¹ and about 10² s⁻¹. In yet other embodiments, the viscous composition is liquid under shear rates of between about 1.0 s⁻¹ and about 10² s⁻¹. The shear rates required to deform the viscous composition to liquid may be measured by a rotational viscometer as described above.

In the embodiment of FIG. 1, the plug 20 is shown to cover the cut edges of the anode layers 12. However, in other embodiments, the plug 20 may additionally cover the cut edges of any one or more of the cathode layers 14, the electrolyte layers 16 and the current collector layers 18.

In certain embodiments, the laminate 15 has a laminate width 32 corresponding to the width of the cut edges 22 and 24, and the viscosity modifier or the plug 20 is present on the entire width 32 of the laminate. In other embodiments, the viscosity modifier or the plug 20 is present on at least a portion of the width 32 of the laminate 15. In some instances, the width 32 of the laminate 15 is between about 100 mm and about 200 mm, and the viscosity modifier or plug 20 is present in a width region spanning up to about 500 microns along the width 32 of the laminate and perpendicular to the cut edge (22 and 24).

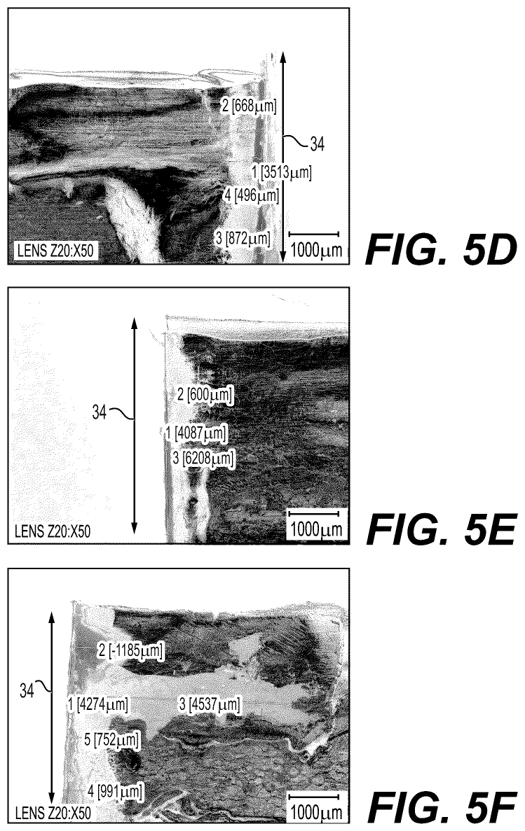

In other embodiments, the laminate 15 has a laminate length 34 best seen in FIG. 3B, and the viscosity modifier is present on at least a portion of the laminate length 34. The viscosity modifier is present on at least a portion of the laminate length 34 to the extent that the viscous composition can extend in between the layers of the laminate 15 by capillary action. In certain implementations of these embodiments, the laminate 15 has a laminate length 34 of between about 550 mm and about 700 mm; and the viscosity modifier or plug 20 is present in a region spanning between about 200 microns and about 2 mm from the cut edge of the laminate along the length 34 of the laminate which may also be referred to as the depth of the cauterizing zone inside of the laminate. In one embodiment, as best seen in FIGS. 5A-5F, the water in a viscous composition comprising Laponite is seen to infiltrate by capillarity between about 200 microns and about 2 mm from the cut edge of the laminate along its length 34. These dimensions are in sharp contrast with the levels of oxidization seen with applications of reactive fluid alone which can extend up to about 5 cm along the length 34 from the cut edge.

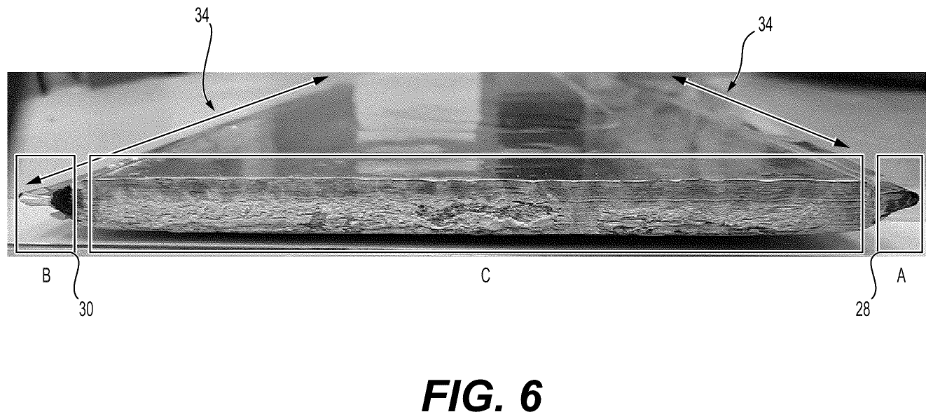

FIG. 6 illustrates a laminate according to another embodiment, wherein the laminate, has zones where electrodes are contacted together, to make electrical contact between the laminates. Zone A has anodes contacted and comprises negative pole 28, zone B, on the opposite side has cathodes contacted and comprises positive pole 30, and zone C is the area cauterized. In certain embodiments, the viscosity modifier is present in a region spanning up to about 50 mm from the cut edge of the laminate along the length 34 at each zone A and zone B comprising the contacted anodes and cathodes respectively.

From another aspect there is provided a method for preparing laminates 15 of the present technology comprising applying a viscous composition as described above to an edge of the laminate 15. In certain embodiments, the method comprises applying the viscous composition along the entire edge of the laminate. As discussed above the application of the viscous composition cauterizes the alkali metal anode layer 12 of the laminate 15 by oxidation and prevents extensive penetration of the reactive fluid in between the layers of the laminate 15.

In certain embodiments, the laminates 15 are first prepared by rolling or stacking thin-filmed sheets of at least a first alkali metal anode layer 12, at least one electrolyte layer 16, and at least a first cathode layer 14, one on top of another in parallel while allowing the anode and current collector to protrude on different longitudinal edges as discussed above (FIG. 3A). A current collector layer 18 may also be added adjacent to and in association with the cathode layer 14 as described above.

In certain embodiments, the layers may be deposited by coating deposition which provides a simple and effective way of producing a highly homogenous laminate. The various films/layers may adhere to one another due to their inherent properties, or may be hot pressed after assembly to create a dense unitary block. Alternatively, adhesion agents such as cross-linkable and non-cross linkable thermal adhesives could be added to further promote and enhance the adhesion of the various layers to one another.

The laminates 15 are then cut perpendicular to their longitudinal axis to obtain a predetermined shape of a laminate 15 with free edges, shown herein as cut edges 22 and 24. The laminate 15 may be cut by any known method known in the arts such as with laser cutting tools, or mechanical cutting operations, such as shear cutting, crush cutting, or punching.

A viscous composition according to certain embodiments of the present technology is then applied to an edge of the laminate. As seen in FIG. 1, the edge is at least a first cut edge 22 of the laminate. In other embodiments, as best seen in FIG. 4, the at least one edge may be the first cut edge 22 and the second cut edge 24.

FIG. 4 illustrates one possible embodiment of the methods of the present technology, wherein apparatus 40 is used to apply the viscous composition to the laminate 15. Apparatus 40 comprises a containment cover 50 having a ventilation aperture 52 (all shown in dashed lines for clarity), a pair of fluid spraying nozzles 54, a pair of airstream nozzles 56, and a wheeled platform 44 mounted on a railing system 45 which is actuated back and forth by reciprocating means 58, such as a pneumatic or hydraulic piston-cylinder assembly, an endless screw or a rack and pinion mechanism.

In this embodiment, the laminate 15 is installed in a protective casing 42 adapted to seal the entire laminate 15 with the exception of the first and second cut edges 22 and 24. The protective casing 42 comprises an opening 43 at each extremity thereof for exposing the entirety of cut edges 22 and 24 of the laminate 15 while sealing the main body of the laminate Protective casing 42 includes two sections (not shown) which are shaped such as to be able to sandwich the laminate 15.

The protective casing 42 enclosing the laminate 15 is securely mounted on a wheeled platform 44 via a quick release fastener 46. Once installed, the laminate 15 is connected to a voltmeter (not shown) so that its voltage may be monitored during the cauterization process. The reciprocating means 58 is then activated and the wheeled platform 44 carrying the laminate moves into containment cover 50 through door 60 at a constant speed along a path defined by railing system 45. The path of the railing system 45 is such that the openings 43 of protective casing 42 will pass directly in front of the pair of spraying nozzles 54. The spraying nozzles 54 are activated by a sensor 53 triggered before wheeled platform 44 enters the cauterization zone to ensure stabilized and constant flow of the viscous composition out of the nozzles 54 prior to the arrival of protective casing 42. Each nozzle 54 sprays a jet 64 of the viscous composition of the present technology, directly onto the cut edges 22 and 24 of the laminate 15, which are exposed through openings 43 of protective casing 42, as the platform 44 travels at constant speed. The wheeled platform 44 carrying laminate 15 continues its course until the entire width 32 of the cut edges 22 and 24 have been sprayed. At this point, the reciprocating means 58 stops the movement of platform 44 and the nozzles 54 are shut down. The platform 44 carrying, laminate 15 may rest at the end of its course for a length of time sufficient to allow the edges of the anodes 12 to chemically react with the reactive fluid and to recede sufficiently, and for the viscosity modifier to form plug 20 and set.

Alternatively, the wheeled platform 44 may be stationary and the fluid spraying nozzles 54 may be actuated back and forth relative to the wheeled platform 44 by reciprocating means 58. In such embodiments, the spraying nozzles 54 may be activated before being actuated to ensure stabilized and constant flow of the viscous composition out of the nozzles 54. Each nozzle 54 may then spray a jet 64 of the viscous composition of the present technology, directly onto the cut edges 22 and 24 of the laminate 15, which are exposed through openings 43 of protective casing 42, as they travel at constant speed along the width 32 of said cut edges. The fluid spraying nozzles continue their course until the entire width 32 of the cut edges 22 and 24 have been sprayed. At this point, the reciprocating means stops the movement of the nozzles 54 and the nozzles are shut down.

In certain embodiments, the spraying nozzles 54 are fully adjustable. The pressure, velocity and shape of the jets may be modified and adjusted as any typical spraying device according to the viscous composition being used.

Exposure of the cut edges 22 and 24 to the viscous composition results in rapid oxidation of the alkali metal anode layer 12 due to the presence of the reactive fluid and to the formation of the plug 20 due to the presence of the viscosity modifier in the composition as shown in FIG. 1 and discussed above.

Without being bound by theory, the formation of the plug 20 and/or increased viscosity/reduced flow afforded by the presence of the viscosity modifier in the viscous composition limits the flow of the reactive fluid on the cut edges 22 and 24 of the laminate once applied. Therefore, in certain embodiment, an optimized volume of reactive fluid is sprayed onto the laminates of the present technology compared to previous methods. In certain embodiments, the volume of reactive fluid, present in the viscous composition, and sprayed onto the laminate is between about 0.5 ml and about 1.5 ml, between about 0.5 ml and about 1.0 ml, between about 1.0 ml and about 1.25 ml, or about 0.8 ml per side. This stands in sharp contrast to previous methods using reactive fluids only, wherein the volume of reactive fluid sprayed was between about 2.5 ml and about 3.3 ml per side and wherein excess reactive fluid needed to be aspirated from the laminate.

Advantageously, the methods of the present technology do not require an aspiration step following cauterization , as optimized volumes of reactive fluid are sprayed. Accordingly, in certain embodiments, apparatus 40 may not comprise any one or more of the pair of airstream nozzles 56, the containment cover 50, the ventilation aperture 52 and the door 60.

It should be understood that the above-described apparatus is but one example of implementation of the application process of the viscosity modifier on the laminate. Other examples such as use of endless belts to carry a plurality of laminates one after the other through a single cauterization zone defined by a pair of spray nozzles, as disclosed in WO 2004/0798036 (incorporated herein by reference), are known in the art and are suitable for the methods of the present technology.

In other embodiments, the viscous composition may also be applied directly onto the cut edges 22 and 24 of the laminate 15 by means of a dispenser brough into contact with the cut edges 22 and 24. Examples of such a dispenser include a brush, felt, broom, sponge, tissue, fabric, cloth or wad, onto which a layer of the viscous composition may be applied and dispensed onto cut edges 22 and 24 through friction of the dispenser against the laminate

In other embodiments, the method may further comprise assessing the cauterization of the laminate after applying the viscous composition to the edge of the laminate. In such embodiments, a camera may be provided in the cauterization zone to detect and insure proper cauterization of the laminate. A plurality of photos may be taken, for example, as the wheeled platform 44 or an endless belt carries the laminate 15 through the cauterization zone. The camera may take any number of photos necessary to assess proper cauterization of the laminate 15 in any number of areas of the cut edges 22 and 24 exposed through opening 43. The images can then be analyzed by a person or through an automated system, such as image learning, to indicate if cauterization has succeeded.

In other embodiments, the colorant in the viscous composition may be used to assess successful application of the viscous composition to the cut edge of the laminate.

Variations and modifications will occur to those of skill in the art after reviewing this disclosure. The disclosed features may be implemented, in any combination and subcombinations (including multiple dependent combinations and subcombinations), with one or more other features described herein. The various features described or illustrated above, including any components thereof, may be combined or integrated in other systems. Moreover, certain features may be omitted or not implemented. Examples of changes, substitutions, and alterations are ascertainable by one skilled in the art and could be made without departing from the scope of the information disclosed herein.

It should be appreciated that the present technology is not limited to the particular embodiments described and illustrated herein but includes all modifications and variations falling within the scope of the present technology as defined in the appended claims.

All references cited in this specification, and their references, are incorporated by reference herein in their entirety where appropriate for teachings of additional or alternative details, features, and/or technical background.

What is claimed is:

1. A laminate for a lithium-ion battery, the laminate comprising:
at least one cathode layer,
at least one anode layer,
at least one electrolyte layer disposed between the at least one cathode layer and the at least one anode layer, and
a viscosity modifier present on at least a portion of the laminate;
wherein the viscosity modifier limits penetration of a reactive fluid into the laminate.

2. The laminate of claim 1, wherein the viscosity modifier is present at an edge of the laminate.

3. The laminate of claim 2, wherein the edge of the laminate corresponds to a cut edge.

4. The laminate of claim 2, wherein the edge of the laminate comprises a plug cauterizing said edge, the plug comprising the viscosity modifier.

5. The laminate of claim 1, wherein the viscosity modifier is a non-Newtonian shear thinning agent, a viscous polymer, or a combination thereof.

6. The laminate of claim 5, wherein the non-Newtonian shear thinning agent is a thixotropic agent.

7. The laminate of claim 6, wherein the thixotropic agent is a synthetic argyle, a natural argyle, or a combination thereof

8. The laminate of claim 7, wherein the synthetic argyle is Laponite.

9. The laminate of claim 7, wherein the natural argyle is a smectite clay.

10. The laminate of claim 9, wherein the smectite clay is Montmorillonite, Bentonite, or a combination thereof

11. The laminate of claim 5, wherein the viscous polymer is a polyvinyl alcohol, a crosslinked polyacrylic acid polymer, a vegetable polymer, or combinations thereof

12. The laminate of claim 11, wherein the vegetable polymer is Xanthan, Agar, Carboxymethyl cellulose, or combinations thereof.

13. The laminate of claim 11, wherein the viscous polymer is a polyvinyl alcohol.

14. The laminate of claim 1, having a laminate length, the viscosity modifier being present in a region spanning up to about 50 mm from the edge of the laminate along the length of the laminate.

15. The laminate of claim 1, having a laminate width, the viscosity modifier being present in a region spanning up to about 500 microns along the width of the laminate and perpendicular to the cut edge of the laminate.

16. The laminate of claim 1, wherein one or more of the cathode layer, the electrolyte layer, and the anode layer is a film.

17. A method for preparing the laminate of claim 1, the method comprising applying a viscous composition to an edge of the laminate.

18. The method of claim 17, wherein the viscous composition comprises the viscosity modifier in an amount ranging from about 1% w/w to about 5% w/w of the total mass of the viscous composition.

19. The method of claim 18, wherein the viscous composition comprises the viscosity modifier in an amount ranging from about 2.0% w/w to about 3.5% w/w of the total mass of the viscous composition.

20. A lithium-ion battery comprising the laminate of claim 1.
